(19) United States
(12) Patent Application Publication
(10) Pub. No.: US 2025/0254764 A1
(43) Pub. Date: Aug. 7, 2025

(54) PHASE CORRECTION FOR INDUCTION COOKING

(71) Applicant: Haier US Appliance Solutions, Inc., Wilmington, DE (US)

(72) Inventor: Ali Jordan Faraji-Tajrishi, Louisville, KY (US)

(21) Appl. No.: 18/430,238

(22) Filed: Feb. 1, 2024

(51) Int. Cl. H05B 6/06

(52) U.S. Cl. CPC H05B 6/062; H05B 2213/05

(57) ABSTRACT

A method for determining a phase in an induction cooking appliance is provided. The method may include determining a measured phase value indicative of a phase difference between an induction coil current and a voltage across a resonant tank of the induction cooking appliance. The method may further include obtaining a phase error of the measured phase value using a phase error approximation model. The method may further include adjusting the measured phase value based, at least in part, on the phase error approximation model to determine an output signal indicative of the induction cooking appliance.

### FIELD

Example aspects of the present disclosure relate to induction heating systems used, for instance, in cooktop appliances, and more particularly to monitoring induction coil phase and current in induction heating systems and apparatuses.

### BACKGROUND

Induction cook-tops heat conductive cookware by magnetic induction. An induction cook-top applies radio frequency current to a heating coil to generate a strong radio frequency magnetic field on the heating coil. When a conductive vessel, such as a pan, is placed over the heating coil, the magnetic field coupling from the heating coil generates eddy currents on the vessel, causing the vessel to increase in temperature.

An induction cook-top will generally heat any vessel of suitable conductive material of any size that is placed on the induction cook-top. Since the magnetic field is not visible, unless some secondary indicator is provided, it is not readily apparent whether the induction cook-top is powered (on) or off. Thus, it is possible for items placed on the induction cook-top to be heated unintentionally, which could damage such items and create other problems.

### SUMMARY

Aspects and advantages of embodiments of the present disclosure will be set forth in part in the following description, or can be learned from the description, or can be learned through practice of the embodiments.

In one example aspect of the present disclosure, a method for determining a phase in an induction cooking appliance is provided. The method may include determining a measured phase value indicative of a phase difference between an induction coil current and a voltage across a resonant tank of the induction cooking appliance. The method may further include obtaining a phase error of the measured phase value using a phase error approximation model. The method may further include adjusting the measured phase value based, at least in part, on the phase error approximation model to determine an output signal indicative of the induction cooking appliance.

Another example aspect of the present disclosure is directed to an induction coil control system for determining a phase in an induction cooking appliance. The induction coil control system includes one or more sensors configured to determine one or more signals indicative of a phase difference between an induction coil current and a voltage across a resonant tank of the induction cooking appliance. The induction coil control system further includes a controller. The controller is configured to determine a measured phase value indicative of a phase difference between an induction coil current and a voltage across a resonant tank of the induction cooking appliance based on the one or more signals. The controller is further configured to obtain a phase error of the measured phase value using a phase error approximation model. The controller is further configured to adjust the measured phase value based, at least in part, on the phase error. The controller is further configured to determine an output signal indicative of the induction cooking appliance based on the adjusted phase value.

Another example aspect of the present disclosure is directed to an induction cooking appliance. The induction cooking appliance includes an induction coil operable to inductively heat a load. The induction cooking appliance further includes an induction coil control system. The induction coil control system includes one or more sensors configured to determine one or more signals indicative of a phase difference between an induction coil current and a voltage across a resonant tank of the induction cooking appliance. The induction coil control system further includes a controller. The controller is configured to determine a measured phase value indicative of a phase difference between an induction coil current and a voltage across a resonant tank of the induction cooking appliance based on the one or more signals. The controller is further configured to obtain a phase error of the measured phase value using a phase error approximation model. The controller is further configured to adjust the measured phase value based, at least in part, on the phase error. The controller is further configured to determine an output signal indicative of the induction cooking appliance based on the adjusted phase value.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an induction cooking appliance according to example embodiments of the present disclosure;

FIG. 2 depicts a schematic implementation of an induction coil control system according to example embodiments of the present disclosure;

FIG. 3 depicts a graphical representation of example signals of the induction coil system according to example embodiments of the present disclosure;

FIG. 4 depicts an example comparator for comparing signals of the induction coil system according to example embodiments of the present disclosure;

FIG. 5 depicts a graphical representation of determining a phase error approximation model according to example embodiments of the present disclosure;

FIG. 6 depicts another graphical representation of determining a phase error approximation model according to example embodiments of the present disclosure;

FIG. 7 depicts a method for determining a phase in an induction cooking appliance according to example embodiments of the present disclosure;

FIG. 8 depicts a method for determining a phase error approximation model according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Some methods for monitoring the phase of one or more induction coils within an induction cooking appliance involve measuring the phase difference between the coil current and the voltage across the resonant tank. The phase difference between the coil current and the voltage across the resonant tank may be referred to herein as the phase value. When measuring and determining this signal indicative of phase value, time errors and/or phase errors may accumulate within the circuit such that the measured phase value is different than the actual phase value of the induction coil. As such, correcting the measured phase value to compensate for errors in the circuit would yield more precise measurements of the phase value. However, the error is difficult to measure as it is dependent on the current during the rise time of the snubber capacitors and may change based on the phase, frequency of operation, and characteristics of the coil or the pan being heated by the coil.

Aspects of the present disclosure are discussed with reference to a single induction coil in a resonant tank for purposes of illustration and discussion. Those of ordinary skill in the art using the disclosures provided herein will understand that aspects of the present disclosure are applicable to systems with a plurality of induction coils and resonant tanks (e.g., coupled in parallel).

According to examples of the present disclosure, a signal indicative of phase error may be added to the measured phase value to yield more precise measurements. The phase error may be based on the error measured at two or more frequency points. From the error measured at those two frequency points, a phase error approximation model (e.g., a linear phase error approximation model) may be determined (e.g., generated) to determine the phase errors over all frequencies of operation. The phase error approximation model may be based in the time domain or the phase domain and may be adjusted based on characteristics of the pan (e.g., pan material, pan size), characteristics of the coil, or any combination of these. For instance, a separate phase error approximation model may be determined for different characteristics of the pan (e.g., pan size, pan material).

In one example aspect of the present disclosure, a method for determining a phase in an induction cooking appliance is provided. The method may include determining a measured phase value indicative of a phase difference between an induction coil current and a voltage across a resonant tank of the induction cooking appliance. The method may further include obtaining a phase error of the measured phase value using a phase error approximation model. The method may further include adjusting the measured phase value based, at least in part, on the phase error to determine an output signal indicative of the induction cooking appliance.

In some embodiments, the phase error approximation model is indicative of the phase error over a plurality of frequencies of operation, the phase error approximation model being determined based on a plurality of frequency point phase errors indicative of phase error, each frequency point measured at one of a plurality of frequency points.

In some embodiments, the method may further include processing the output signal indicative of the induction cooking appliance to determine an output power of the induction cooking appliance.

In some embodiments, the method may further include processing the output signal indicative of the induction cooking appliance to determine a pan presence of the induction cooking appliance.

In some embodiments, the phase error approximation model is based in time domain.

In some embodiments, the phase error approximation model is based in frequency domain.

In some embodiments, the phase error approximation model is based, at least in part, on induction coil characteristics of the induction cooking appliance.

In some embodiments, the phase error approximation model is based, at least in part, on pan characteristics of the induction cooking appliance.

In some embodiments, the measured phase value is determined based, at least in part, on the voltage across the resonant tank, the voltage across the resonant tank being determined by a signal indicative of a voltage across a low side switching device.

In some embodiments, the plurality of frequency point phase errors is determined based, at least in part, on filter capacitor delay, deadtime error, or rise time error of the induction cooking appliance.

In some embodiments, the measured phase value is determined based, at least in part, on a PWM input signal to a gate driver circuit used to control output power of the induction cooking appliance.

Another example aspect of the present disclosure is directed to an induction coil control system for determining a phase in an induction cooking appliance. The induction coil control system includes one or more sensors configured to determine one or more signals indicative of a phase difference between an induction coil current and a voltage across a resonant tank of the induction cooking appliance. The induction coil control system further includes a controller. The controller is configured to determine a measured phase value indicative of a phase difference between an induction coil current and a voltage across a resonant tank of the induction cooking appliance based on the one or more signals. The controller is further configured to obtain a phase error of the measured phase value using a phase error approximation model. The controller is further configured to adjust the measured phase value based, at least in part, on the phase error. The controller is further configured to determine an output signal indicative of the induction cooking appliance based on the adjusted phase value.

In some embodiments, the controller is further configured to process the output signal indicative of the induction cooking appliance to determine an output power of the induction cooking appliance.

In some embodiments, the controller is further configured to process the output signal indicative of the induction cooking appliance to determine a pan presence of the induction cooking appliance.

In some embodiments, the phase error approximation model is based in time domain.

In some embodiments, the phase error approximation model is based in frequency domain.

In some embodiments, the phase error approximation model is a linear phase error approximation model.

In some embodiments, the phase error approximation model is based, at least in part, on pan characteristics of the induction cooking appliance.

In some embodiments, the measured phase value is determined based, at least in part, on the voltage across the resonant tank, the voltage across the resonant tank being determined by a signal indicative of a voltage across a low side switching device.

In some embodiments, the phase error approximation model is indicative of the phase error over a plurality of frequencies of operation, the phase error approximation model being determined based on a plurality of frequency point phase errors indicative of phase error, each frequency point measured at one of a plurality of frequency points.

In some embodiments, the plurality of frequency point phase errors are determined based, at least in part, on filter capacitor delay, deadtime error, or rise time error of the induction cooking appliance.

Another example aspect of the present disclosure is directed to an induction cooking appliance. The induction cooking appliance includes an induction coil operable to inductively heat a load. The induction cooking appliance further includes an induction coil control system. The induction coil control system includes one or more sensors configured to determine one or more signals indicative of a phase difference between an induction coil current and a voltage across a resonant tank of the induction cooking appliance. The induction coil control system further includes a controller. The controller is configured to determine a measured phase value indicative of a phase difference between an induction coil current and a voltage across a resonant tank of the induction cooking appliance based on the one or more signals. The controller is further configured to obtain a phase error of the measured phase value using a phase error approximation model. The controller is further configured to adjust the measured phase value based, at least in part, on the phase error. The controller is further configured to determine an output signal indicative of the induction cooking appliance based on the adjusted phase value.

Aspects of the present disclosure, including correcting the measured phase value with the addition of a phase error generated by a phase error approximation model, has many technical effects and benefits. Correcting the measured phase value to compensate for errors in the circuit yields more precise estimations of the power delivered to the pan. The addition of the phase error also improves other estimations of electrical parameters and system values, such as an equivalent series inductance and resistance to represent the pan and coil or the temperature of the pan on the coil. Further, using a phase error approximation model to generate the phase error provides for faster determination of an accurate phase error when the system is in operation.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

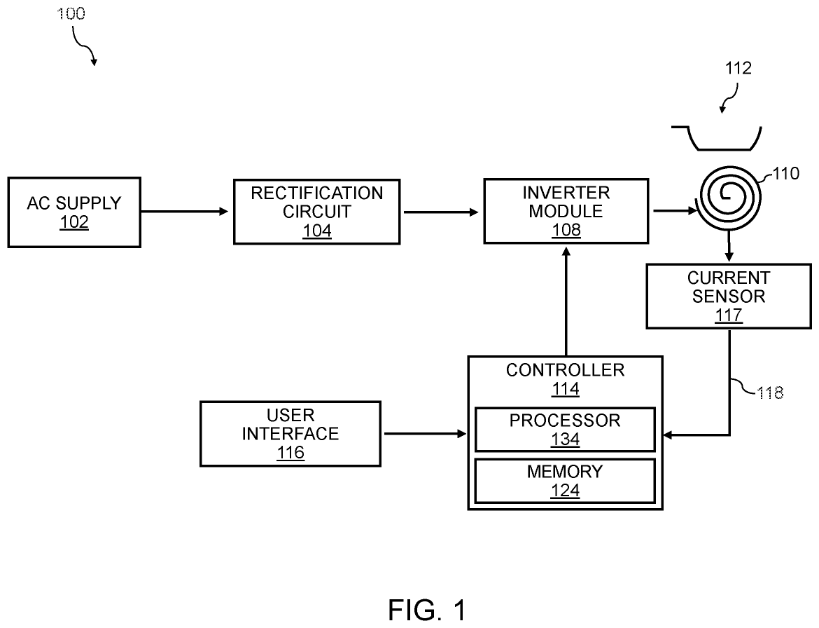

FIG. 1 depicts a block diagram of an induction heating system according to example embodiments of the present disclosure. In operation, the induction cooking appliance 100 can be configured to detect a presence of a vessel 112 (e.g., a pan) on an induction heating coil 110 and control the power supplied to the induction heating coil 110. In some embodiments, induction cooking appliance 100 may be configured to control the power supplied to the induction heating coil 110 at a power level selected by a user from a range of user selectable power settings, where the power supplied is based on size and type of vessel detected and selected power setting.

As shown schematically in FIG. 1, the induction cooking appliance 100 generally includes an AC supply 102, which may provide conventional 60 Hz 120 or 240 volt AC supplied by utility companies, and a rectifier circuit 104 for rectifying the power signal from AC supply 102. Rectifier circuit 104 may include filter and power factor correction circuitry to filter the rectified voltage signal. The induction cooking appliance 100 also includes an inverter module 108 for supplying an alternating current to the induction heating coil 110. In some embodiments, the inverter module 108 may also be termed a variable frequency inverter module. The induction heating coil 110, when supplied by the inverter module 108 with an alternating current, inductively heats the cooking vessel 112 (e.g., pan, load) or other object placed on, over, or near the induction heating coil 110. It will be understood that use of the term “cooking vessel” herein is merely exemplary, and that term will generally include any object of a suitable type that is capable of being heated by an induction heating coil.

The frequency of the current supplied to the induction heating coil 110 by inverter module 108 and hence the output power of the induction heating coil 110 is controlled by controller 114 which controls the switching frequency of the inverter module 108. The controller 114 may include a microcontroller and/or gate driver to drive individual transistors or switching devices of the induction cooking appliance 100 with pulse-width modulated signals. Controller 114 may include memory 124 and one or more processors 134 such as microprocessors, CPUs or the like, such as general or special purpose microprocessors operable to execute programming instructions or micro-control code associated with operation of induction cooking appliance 100. Memory 124 may represent random access memory such as DRAM, or read only memory such as ROM or FLASH. In one embodiment, the processor 134 executes programming instructions stored in memory 124. Memory 124 may be a separate component from controller 114 or may be included onboard controller 114.

In some embodiments, induction cooking appliance 100 may further include a user interface 116 that allows a user to establish the power output of the induction heating coil 110 by selecting a power setting from a plurality of user selectable settings. User interface 116 may be operatively connected to controller 114. A current sensor 117 senses the current supplied to the induction heating coil 110 by the inverter circuit 108 and provides a current signal 118 to controller 114. The current sensor signal 118 is a signal that is representative of the current flowing through the induction heating coil 110 derived from one of a plurality of possible devices. For example, current sensor 117 may include a current transformer, a current shunt monitor, a Hall-Effect sensor, or any suitable current sensing device. In some embodiments, an induction coil control system may be defined as controller 114. Alternatively, the induction coil control system may include controller 114 as well as one or more sensors (e.g., current sensor 117) configured to determine one or more signals (e.g., current sensor signal 118) indicative of a phase difference between an induction coil current and a voltage across a resonant tank of the induction cooking appliance 100.

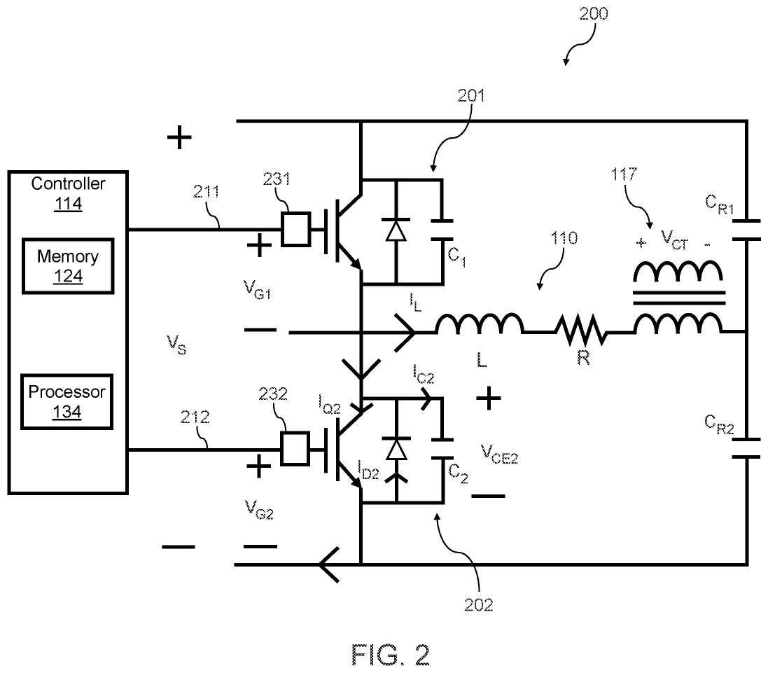

FIG. 2 depicts a schematic implementation of an induction coil system according to example embodiments of the present disclosure. As shown in FIG. 2, the induction heating coil 110 is coupled between high-side switching device 201 and low-side switching device 202. As such, switching devices 201, 202 provide alternating current to the induction heating coil 110 at a desired frequency. The induction coil system 200 may include controller 114, which is configured to set this desired frequency by controlling switching devices 201, 202 with pulse-width modulated input signals 211, 212. The induction heating system may further include gate driver circuits 231, 232 (e.g., gate drivers) coupled between the controller 114 and switching devices 201, 202. Specifically, controller 114 may be configured to send pulse-width modulated input signals 211, 212 to gate driver circuits 231, 232 respectively. As such, Gate driver circuits 231, 232 are configured to control (e.g., drive) switching devices 201, 202 respectively based on pulse-width modulated input signals 211, 212 from controller 114. In some embodiments, switching devices 201, 202 may be Insulated-Gate Bipolar Transistors (e.g., IGBTs). However, other suitable switching devices (e.g., MOSFETs) may be used without deviating from the scope of the present disclosure. Switching devices 201, 202 may be configured in parallel with snubber capacitors e.g., (C₁ and C₂).

Induction coil system 200 further includes current sensor 117 configured to sense the current flowing through the induction heating coil 110 (e.g., i_{L}). As shown, current sensor 117 may be configured to sense the induction coil current (e.g., i_{L}) by measuring voltage V_{CT}. As such, V_{CT} may be a voltage representation of induction coil current i_{L}. In some embodiments, current sensor 117 may include a current transformer. As such, V_{CT} may be defined as a rectified voltage representation of the current transformer.

Induction heating coil 110 and, if present, cooking vessel 112 (shown in FIG. 1) may be represented as an inductor (e.g., L) and a resistor (e.g., R). Induction heating coil 110 (with associated resistance R) and resonant capacitors C_{R1} and C_{R2} form a resonant tank that can serve as a signal filter. In some embodiments, the voltage across the resonant tank may be determined from the pulse-width modulated input signal 211 from the controller 114 to the gate driver circuit 231 of high-side switching device 201 (e.g., gate driver of high-side IGBT). Alternatively, the voltage across the resonant tank may be determined by a signal indicative of a voltage across a low side switching device such as V_{CE2}. In some embodiments, V_{CE2} may be determined using a voltage divider circuit across the low-side switching device 202. Controller 114 is configured to determine a measured phase value indicative of a phase difference between the induction coil current i_{L} and the voltage across a resonant tank.

The measured phase value may be different from the actual phase value of the system due to timing delay and measurement errors. For example, filter capacitor delay may be defined as the time delay of current sensor signal 118 as it travels from current sensor 117 to controller 114. Further, deadtime error may be defined as a combination of the switching device 201, 202 turn off time and the rise time of the snubber capacitors (C₁ and C₂ across 201 and 202 respectively) subtracted from the deadtime between V_{G1} and V_{G2} PWM switching signals. Rise time error may be defined as the rise time of the snubber capacitors (e.g., C₁ and C₂). As such, controller 114 is configured to adjust the measured phase value using a phase error that may be based, at least in part, on filter capacitor delay, deadtime error, and rise time error.

In some embodiments, controller 114 may adjust the measured phase value using a phase error generated by a phase error approximation model as discussed below. The phase error approximation model may be saved in memory 124 of the controller 114.

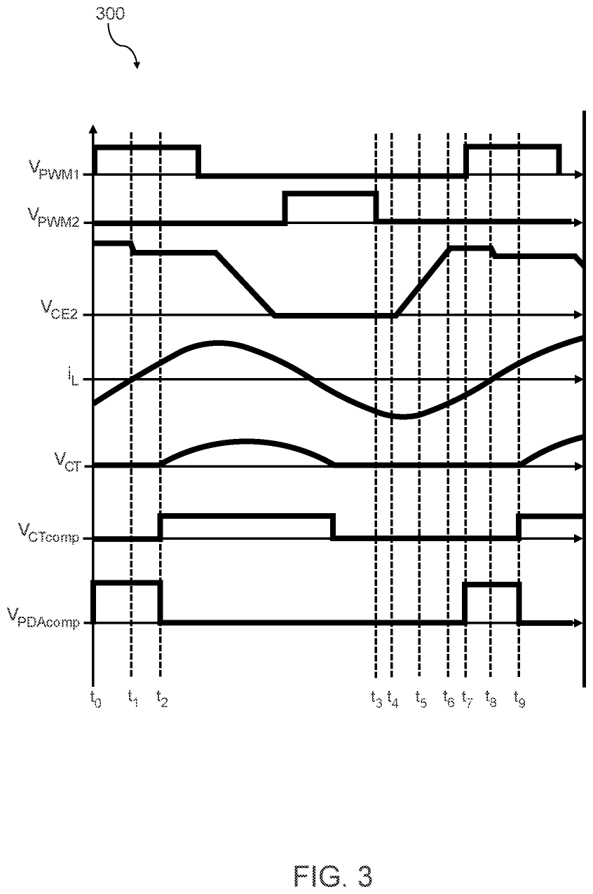

Referring now to FIG. 3, a graphical representation of example signals 300 of the induction coil system 200 is shown. As shown in FIG. 3, V_{PWM1} is a signal indicative of the voltage across the resonant tank. As seen above in FIG. 2, V_{PWM1} may be the pulse-width modulated input signal 211 from the controller 114 to the high-side switching device 201. V_{PWM2} may comprise the pulse-width modulated input signal 212 from the controller 114 to the low-side switching device 202. V_{CE2} represents the voltage across capacitor C₂ of the low-side switching device 202.

Signal V_{CT} may be a voltage representation of induction coil current i_{L}. V_{CTcomp} is a voltage signal indicative of induction coil current i_{L}. In some embodiments, V_{CTcomp} is a conditioned representation of V_{CT}. For example, V_{CTcomp} may be high at a time when V_{CT} is greater than a given voltage threshold and low when V_{CT} is less than said given voltage threshold.

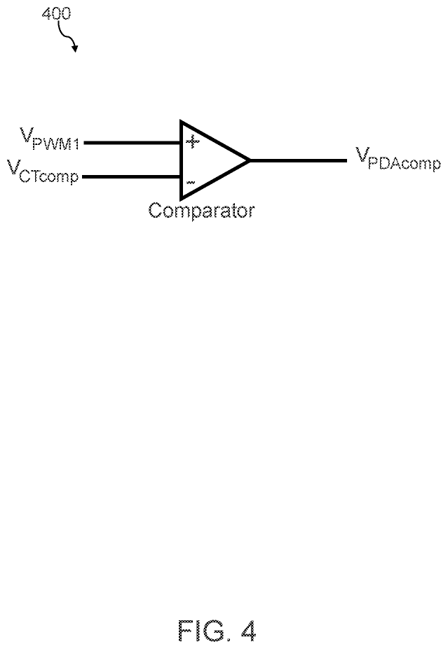

As shown in FIG. 4, V_{PWM1} and V_{CTcomp} may be inputs to a comparator 400 to yield V_{PDAcomp}. Specifically, V_{PDAcomp} may be high only when V_{PWM1} is high and V_{CTcomp} is low such as at t₁ and t₈. The V_{PDAcomp} signal may then be used to determine a measured phase value indicative of a phase difference between the induction coil current i_{L} and the voltage across a resonant tank. Specifically, the phase value may be measured by the time in which V_{PDAcomp} is high. As seen in FIG. 3, this time corresponds to t₇ to t₉, such that the measured phase value equals t₉−t₇. The actual phase difference between the induction coil current i_{L} and the voltage across the resonant tank corresponds to the time period from t₅ to t₈, such that the actual phase value equals t₈−t₅. Accordingly, the actual phase difference occurs from t₅ to t₈, yet due to phase errors and delays, the measured phase difference is determined as occurring from t₇ to t₉. As such, the measured phase value is adjusted using a phase error to provide the actual phase value. Specifically, the phase error is added to the measured phase value to yield the actual phase value.

In some embodiments, the phase error is determined based, at least in part, on the filter capacitor delay, deadtime error, and/or rise time error of the induction cooking appliance. In some embodiments, the phase error may equate to rise time error+deadtime error−filter capacitor delay. Referring now to FIG. 3, filter capacitor delay may correspond to the time period from t₁ to t₂ or from t₈ to t₉ of example signals 300. As such, the filter capacitor delay may equate to t₉−t₈ or t₂−t₁. The rise time error of example signals 300 may correspond to the time period from t₄ to t₅, such that the rise time error equates to t₅−t₄. The deadtime error of example signals 300 may correspond to the time period from t₆ to t₇, such that the deadtime error equates to t₇−t₆.

Computations involved in determining the phase error of a measured phase value may be time consuming and difficult to determine. As such, aspects of the present disclosure incorporate a phase error approximation model to determine phase error.

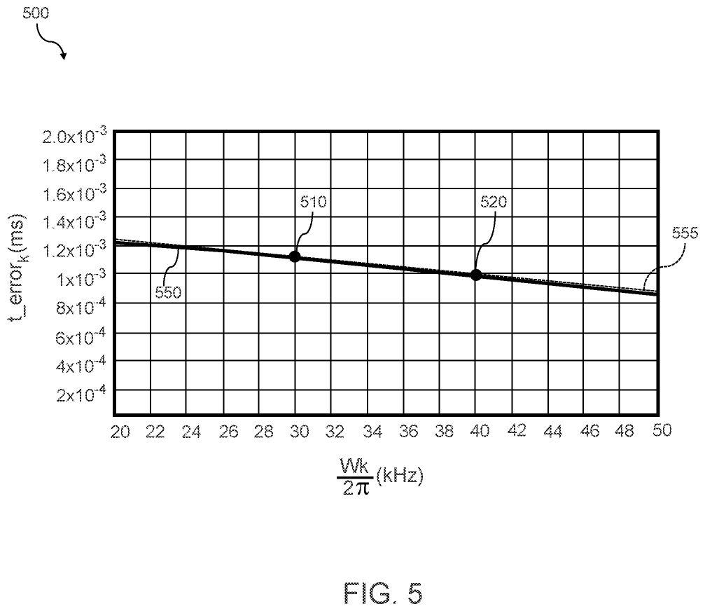

FIG. 5 depicts a graphical representation of determining an example phase error approximation model according to example embodiments of the present disclosure. As shown in graph 500, phase error approximation model 555 may be depicted as a curve generated between a plurality of frequency point phase errors. As such, phase error approximation model 555 may exist in memory 124 of controller 114 as shown in FIGS. 1 and 2. Phase error approximation model 555 may be based, at least in part on a plurality of frequency point phase errors 510, 520. Specifically, the plurality of frequency point phase errors may be used to determine (e.g., generate) phase error approximation model 555. Line 550 of graph 500 depicts the actual phase error determined through calculations such as those shown in FIG. 3. As seen, phase error approximation model 555 provides a highly accurate estimation of line 550 (e.g., actual phase errors).

A first frequency point phase error 510 may be determined as shown in FIG. 3 by controller 114 of induction coil system 200 while the induction cooking appliance 100 is operating at a first frequency. First frequency point phase error 510 may be defined as a first phase error of a first measured phase value at a first operating frequency. A second frequency point phase error 520 may be determined as shown in FIG. 3 by controller 114 of induction coil system 200 while induction cooking appliance 100 is operating at a second frequency. Second frequency point phase error 520 may be defined as a second phase error of a second measured phase value at a second operating frequency. Although not shown, one skilled in the art will understand that additional frequency point phase errors may be determined without deviating from the scope of the present disclosure.

Phase error approximation model 555 is determined (e.g., generated) using the plurality of frequency point phase errors 510, 520. As seen above in FIG. 3, the frequency point phase errors 510, 520 may be determined based, at least in part, on filter capacitor delay, deadtime error, or rise time error of the induction cooking appliance. Phase error approximation model 555 may be based in the time domain. Specifically, frequency point phase errors 510, 520 may be mapped in the time domain about the Y-axis as shown by t_errorₖ in a unit such as millisecond (ms). The operating frequency at which the frequency point phase errors 510, 520 were measured at may be mapped on the X-axis. For example, frequency point phase error 510 was measured at 30 kHz while frequency point phase error 520 was measured at 40 kHz. In some embodiments, phase error approximation model 555 may be a linear phase error approximation model, such that curve 555 is generated using the plurality of frequency point phase errors 510, 520. In some embodiments, phase error approximation model 555 may be based, at least in part, on characteristics of the coil and/or characteristics of the pan.

In some embodiments, phase error approximation model 555 is saved in memory 124 of controller 114 such that controller 114 can quickly and accurately determine a phase error of a measured phase value using the phase error approximation model 555. For example, controller 114 may determine a measured phase value of the induction cooking appliance 100. Controller 114 may then use phase error approximation model 555 to determine a phase error of the measured phase value based on the operating frequency of the induction cooking appliance 100 when the measured phase value was determined.

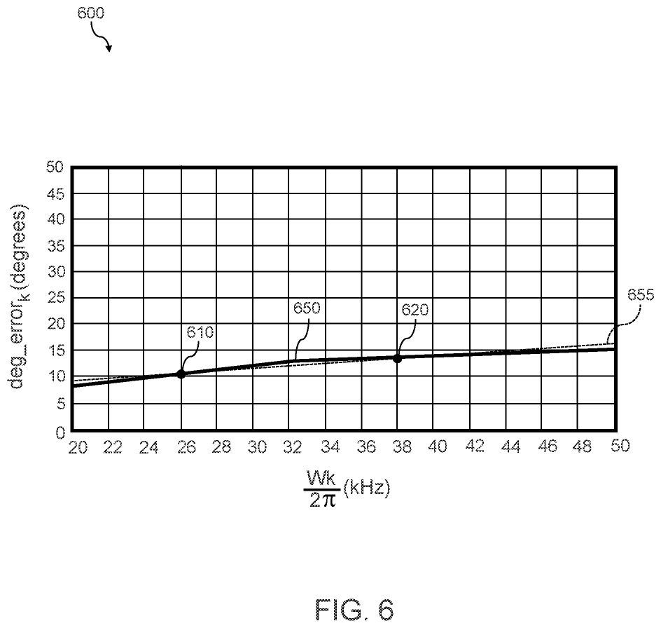

FIG. 6 depicts a graphical representation of determining a phase error approximation model according to example embodiments of the present disclosure. As shown in graph 600, phase error approximation model 655 may be depicted as a curve (e.g., linear curve) generated between the plurality of frequency point phase errors 610, 620. As such, phase error approximation model 655 may exist in the memory 124 of controller 114 as shown in FIGS. 1 and 2. Phase error approximation model 655 may be based, at least in part on a plurality of frequency point phase errors 610, 620. Specifically, the plurality of frequency point phase errors may be used to generate phase error approximation model 655. Line 650 of graph 600 depicts the actual phase error determined through calculations such as those shown in FIG. 3. As seen, phase error approximation model 655 provides a highly accurate estimation of line 650 (e.g., actual phase errors).

A first frequency point phase error 610 may be determined as shown in FIG. 3 by controller 114 of induction coil system 200 while the induction cooking appliance 100 is operating at a first frequency. First frequency point phase error 610 may be defined as a first phase error of a first measured phase value at a first operating frequency. A second frequency point phase error 620 may be determined as shown in FIG. 3 by controller 114 of induction coil system 200 while induction cooking appliance 100 is operating at a second frequency. Second frequency point phase error 620 may be defined as a second phase error of a second measured phase value at a second operating frequency. Although not shown, one skilled in the art will understand that additional frequency point phase errors may be determined without deviating from the scope of the present disclosure.

Phase error approximation model 655 is determined (e.g., generated) using the plurality of frequency point phase errors 610, 620. As seen above in FIG. 3, the frequency point phase errors 610, 620 may be determined based, at least in part, on filter capacitor delay, deadtime error, or rise time error of the induction cooking appliance. Phase error approximation model 655 may be based in the frequency domain. Specifically, frequency point phase errors 610, 620 may be mapped in the frequency domain about the Y-axis as shown by deg_errorₖ in a unit such as degrees. The operating frequency at which the frequency point phase errors 610, 620 were measured at may be mapped on the X-axis. For example, frequency point phase error 610 was measured at 26 kHz while frequency point phase error 620 was measured at 38 kHz. In some embodiments, phase error approximation model 655 may be a linear phase error approximation model, such that curve 650 is generated using the plurality of frequency point phase errors 610, 620. In some embodiments, phase error approximation model 655 may be based, at least in part, on characteristics of the coil and/or characteristics of the pan.

In some embodiments, phase error approximation model 655 is saved in memory 124 of controller 114 such that controller 114 can quickly and accurately determine a phase error of a measured phase value using the phase error approximation model 655. For example, controller 114 may determine a measured phase value of the induction cooking appliance 100. Controller 114 may then use phase error approximation model 655 to determine a phase error of the measured phase value based on the operating frequency of the induction cooking appliance 100 when the measured phase value was determined.

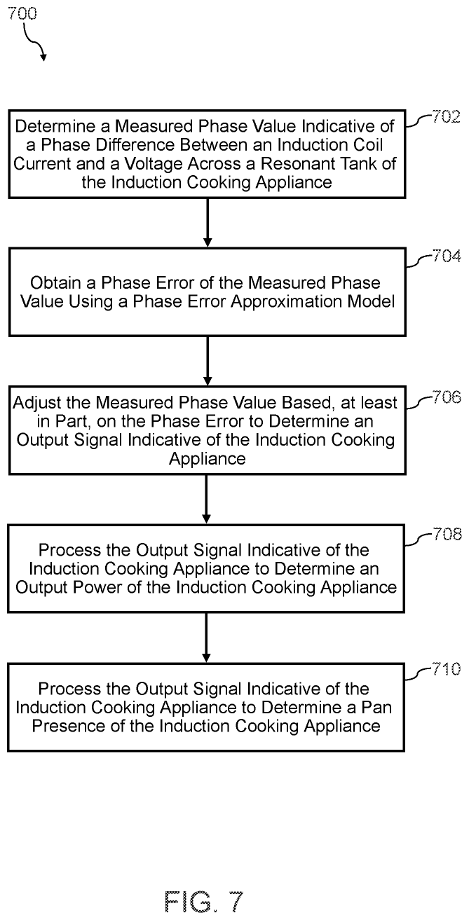

FIG. 7 depicts a flowchart of a method 700 for determining a phase in an induction cooking appliance, such as induction cooking appliance 100 of FIG. 1. Method 700 may be implemented by an induction coil control system to determine a phase in induction cooking appliance 100. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Method 700 is generally discussed with reference to the induction cooking appliance 100 described above with reference to FIG. 1 and induction coil system 200 described above with reference to FIG. 2. However, it should be understood that aspects of the method 700 can be implemented with any suitable appliance and/or control system.

At 702, method 700 includes determining a measured phase value indicative of a phase difference between an induction coil current and a voltage across a resonant tank of the induction cooking appliance.

At 704, method 700 further includes obtaining a phase error of the measured phase value using a phase error approximation model. At 706, method 700 further includes adjusting the measured phase value based, at least in part, on the phase error to determine an output signal indicative of the induction cooking appliance.

In some embodiments, method 700 may further include, at 708, processing the output signal indicative of the induction cooking appliance to determine an output power of the induction cooking appliance. In some embodiments, the output power may be determined based on the processed output signal as well as other signals of the induction cooking appliance. In some embodiments, method 700 may further include, at 710, processing the output signal indicative of the induction cooking appliance to determine a pan presence of the induction cooking appliance.

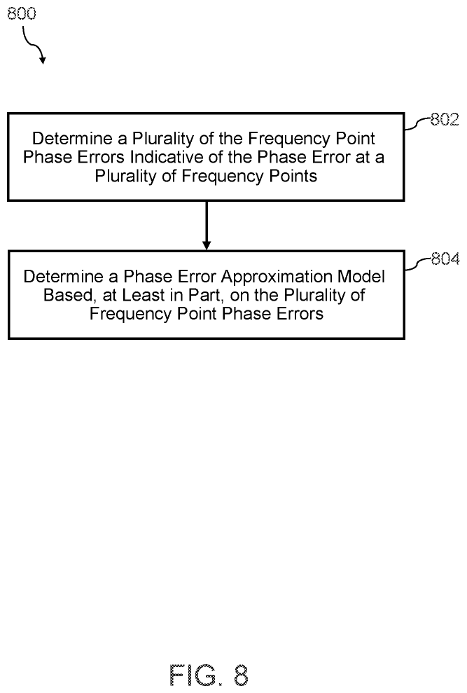

FIG. 8 depicts a method 800 for determining a phase error approximation model according to example aspects of the present disclosure. Method 800 may be used to determine a phase error approximation model such as that shown in method 700 depicted in FIG. 7. Further, phase error approximation model 555 shown in FIG. 5 or phase error approximation model 655 shown in FIG. 6 may be determined using method 800. Method 800 is generally discussed with reference to the induction cooking appliance 100 described above with reference to FIG. 1 and induction coil system 200 described above with reference to FIG. 2. However, it should be understood that aspects of the method 800 can be implemented with any suitable appliance and/or system to determine any suitable phase approximation model.

At 802, method 800 includes determining a plurality of frequency point phase errors indicative of the phase error at a plurality of frequency points.

At 804, method 800 further includes determining a Phase Error Approximation Model based, at least in part, on the plurality of frequency point phase errors.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for determining a phase in an induction cooking appliance, the method comprising:
determining a measured phase value indicative of a phase difference between an induction coil current and a voltage across a resonant tank of the induction cooking appliance;
obtaining a phase error of the measured phase value using a phase error approximation model; and
adjusting the measured phase value based, at least in part, on the phase error to determine an output signal indicative of the induction cooking appliance.

2. The method of claim 1, wherein the phase error approximation model is indicative of the phase error over a plurality of frequencies of operation, the phase error approximation model being determined based on a plurality of frequency point phase errors indicative of phase error, each frequency point measured at one of a plurality of frequency points.

3. The method of claim 1 further comprising:
processing the output signal indicative of the induction cooking appliance to determine an output power of the induction cooking appliance.

4. The method of claim 1 further comprising:
processing the output signal indicative of the induction cooking appliance to determine a pan presence of the induction cooking appliance.

5. The method of claim 1, wherein the phase error approximation model is based in time domain.

6. The method of claim 1, wherein the phase error approximation model is based in frequency domain.

7. The method of claim 1, wherein the phase error approximation model is based, at least in part, on induction coil characteristics or pan characteristics of the induction cooking appliance.

8. The method of claim 1, wherein the measured phase value is determined based, at least in part, on the voltage across the resonant tank, the voltage across the resonant tank being determined by a signal indicative of a voltage across a low side switching device.

9. The method of claim 2, wherein the plurality of frequency point phase errors are determined based, at least in part, on filter capacitor delay, deadtime error, or rise time error of the induction cooking appliance.

10. The method of claim 1, wherein the measured phase value is determined based, at least in part, on a PWM input signal to a gate driver circuit used to control output power of the induction cooking appliance.

11. An induction coil control system for determining a phase in an induction cooking appliance, the system comprising:
one or more sensors configured to determine one or more signals indicative of a phase difference between an induction coil current and a voltage across a resonant tank of the induction cooking appliance;
a controller configured to:
determine a measured phase value indicative of a phase difference between an induction coil current and a voltage across a resonant tank of the induction cooking appliance based on the one or more signals;
obtain a phase error of the measured phase value using a phase error approximation model;
adjust the measured phase value based, at least in part, on the phase error; and
determine an output signal indicative of the induction cooking appliance based on the adjusted phase value.

12. The induction coil control system of claim 11, wherein the controller is further configured to process the output signal indicative of the induction cooking appliance to determine an output power of the induction cooking appliance.

13. The induction coil control system of claim 11, wherein the controller is further configured to process the output signal indicative of the induction cooking appliance to determine a pan presence of the induction cooking appliance.

14. The induction coil control system of claim 11, wherein the phase error approximation model is based in time domain.

15. The induction coil control system of claim 11, wherein the phase error approximation model is based in frequency domain.

16. The induction coil control system of claim 11, wherein the phase error approximation model is a linear phase error approximation model.

17. The induction coil control system of claim 11, wherein the phase error approximation model is based, at least in part, on pan characteristics of the induction cooking appliance.

18. The induction coil control system of claim 11, wherein the phase error approximation model is indicative of the phase error over a plurality of frequencies of operation, the phase error approximation model being determined based on a plurality of frequency point phase errors indicative of phase error, each frequency point measured at one of a plurality of frequency points.

19. The induction coil control system of claim 18, wherein the plurality of frequency point phase errors are determined based, at least in part, on filter capacitor delay, deadtime error, or rise time error of the induction cooking appliance.

20. An induction cooking appliance, comprising:
an induction coil operable to inductively heat a load; and
an induction coil control system, the system comprising:
one or more sensors configured to determine one or more signals indicative of a phase difference between an induction coil current and a voltage across a resonant tank of the induction cooking appliance;
a controller configured to:
determine a measured phase value indicative of a phase difference between an induction coil current and a voltage across a resonant tank of the induction cooking appliance based on the one or more signals;
obtain a phase error of the measured phase value using a phase error approximation model;
adjust the measured phase value based, at least in part, on the phase error; and
determine an output signal indicative of the induction cooking appliance based on the adjusted phase value.
